(19) United States
(12) Patent Application Publication
(10) Pub. No.: US 2008/0182121 A1
(43) Pub. Date: Jul. 31, 2008

(54) COPPER ALUMINUM LAMINATE FOR REPLACING SOLID COPPER SHEETING

(75) Inventor: Michael A. Michaud, Acton, ME (US)

Correspondence Address: MESMER & DELEAULT, PLLC, 1 NEW HAMPSHIRE AVE., SUITE 125, PORTSMOUTH, NH, 03801, US

(73) Assignee: York Manufacturing, Inc., Sanford, ME (US)

(21) Appl. No.: 12/021,990

(22) Filed: Jan. 29, 2008

Related U.S. Application Data
(60) Provisional application No. 60/887,003, filed on Jan. 29, 2007.

(51) Int. Cl. B32B 15/20; C09J 5/00

(52) U.S. Cl. 428/606; 428/652; 428/621; 156/60

(57) ABSTRACT

The invention is a laminate made of very thin copper sheet preferably between 0.0005 and 0.01 inches thick, aluminum sheet preferably between 0.004 and 0.04 inches thick, and adhesive between the copper and aluminum sheets. The cost of the aluminum, adhesive, and the manufacturing process combined are much less expensive than solid copper sheet of 0.020 inches in thickness. However, when the copper sheet of the laminate is on the outside, the aesthetic qualities are indistinguishable from heavyweight solid copper sheet.

### BACKGROUND

1. Field of the Invention

The invention is in the field of multi-layer laminates used in building construction.

2. Description of the Related Art

Heavyweight copper sheeting is widely used in building construction for its aesthetic benefits, malleability, and other fine qualities. It is used in a broad array of applications, including flashing, window caps, drip edges, valley flashing, gutters, cupolas, ceiling tiles, and for general upgrades of existing structures. The typical thickness of solid copper sheeting that is used is 0.020 inches thick.

Nowadays, solid copper sheeting is extremely expensive. Yet, it remains highly desirable. What is needed, therefore, is a product that has all the desirable characteristics of solid copper sheeting, but costs less.

### SUMMARY

The invention is an article of manufacture that satisfies the need for a product that has all the desirable characteristics of solid copper sheeting, but costs much less. The invention is a laminate made of very thin copper sheet between 0.0005 and 0.01 inches thick, aluminum sheet between 0.004 and 0.04 inches thick, and adhesive between the copper and aluminum sheets. The cost of the aluminum, adhesive, and the manufacturing process combined are much less expensive than solid copper sheet of 0.020 inches in thickness. However, when the copper sheet of the laminate is showing on the outside, the aesthetic qualities are indistinguishable from heavyweight solid copper sheet. These and other benefits and advantages will become more apparent in the following drawing, description, and claims.

### DRAWINGS

FIG. 1 is an orthogonal view of a laminate according to the present invention.

### DESCRIPTION

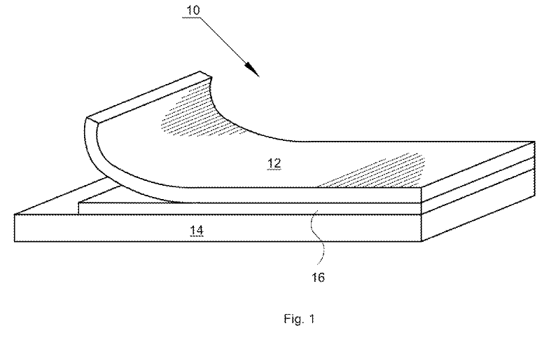

The invention is a laminate made of very thin copper sheet, aluminum sheet, and hot melt rubber adhesive between the copper and aluminum sheets. Turning to FIG. 1, the copper-aluminum laminate 10 has a sheet of copper 12 preferably between 0.0005 and 0.01 inches thick. The laminate also has a sheet of aluminum 14 preferably between 0.004 and 0.04 inches thick. These thicknesses were selected from experience.

Disposed between the sheets to adhere them together is a layer of adhesive 16. The adhesive 16 is preferably hot melt rubber adhesive, but other adhesives can be used.

The cost of the laminate 10 is much less than the cost of heavyweight solid copper sheeting of a standard 0.020 inch thickness. Typically, the cost is one-third the price of traditional copper. Yet, it retains all of the desirable properties of solid copper sheeting. The combination yields the benefits of beauty, strength, and affordability.

The aluminum sheet 14 may have a coating disposed on it that creates a galvanic isolation barrier. The isolation barrier prevents galvanic corrosion between the aluminum 14 and copper 12. An example is LINCOAT coating provided by York Manufacturing, Inc.

The laminate 10 is designed to pass several performance tests, including but not limited to a 5% sodium chloride spray at 35 degrees C. for 1000 hours per ASTM B117, a warm mandrel bend conducted after 40 hours of exposure at 140 degrees F., and a cold mandrel bend conducted after 40 hours of exposure at −140 degrees F.

Additional tests performed on the aluminum include, without limitation, exposure to concentrated nitric acid at 30 degrees C. for 24 hours per ASTM G67, and exposure to 6% sodium chloride solution with hydrogen peroxide additions at 25 degrees C. for 6 hours per ASTM G110, also designated as Mil Spec H-6008G.

The copper sheet 12 can be copper foil per UNS #C11000, coiled as per ASTM B248-06, ASTM B152/B152M-00, and ASTM B370-98.

The laminate can be made by providing an aluminum sheet 14, and applying an adhesive 16 to the aluminum sheet 14, and applying a copper sheet 12 over the adhesive 16. The aluminum sheets 14 may be coated with an isolation barrier coating to prevent galvanic corrosion between the copper and aluminum.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

What is claimed is:

1. A building construction laminate comprising:
a copper sheet;
an aluminum sheet; and
adhesive disposed between the copper and aluminum forming a laminate, whereby the laminate can replace thicker solid copper sheets by minimizing the amount of copper used while maintained the overall aesthetic quality of copper.

2. The building construction laminate of claim 1, wherein the copper sheet is between 0.0005 and 0.0100 inches thick.

3. The building construction laminate of claim 1, wherein the aluminum sheet between 0.004 and 0.04 inches thick.

4. The building construction laminate of claim 1, further comprising an isolation barrier coating disposed on the aluminum sheet for preventing galvanic corrosion between the copper sheet and aluminum sheet.

5. The building construction laminate of claim 1, wherein the adhesive is a hot melt rubber adhesive.

6. A method of making a building construction laminate comprising the steps of:
providing an aluminum sheet;
applying an adhesive to the aluminum sheet; and
applying a copper sheet over the adhesive.

7. The method of claim 6, further comprising the step of coating the aluminum sheet with an isolation barrier before applying adhesive to prevent galvanic corrosion between the copper and aluminum.

8. The product made by the process of claim 6.
